(19) United States
(12) Patent Application Publication
(10) Pub. No.: US 2006/0201986 A1
(43) Pub. Date: Sep. 14, 2006

(54) Optical fiber cutting device

(75) Inventors: Katsumi Sasaki, Sakura-shi (JP); Taku Otani, Sakura-shi (JP); Seiji Horino, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD.

(21) Appl. No.: 11/356,163

(22) Filed: Feb. 17, 2006

(30) Foreign Application Priority Data
Mar. 8, 2005 (JP) P2005-63953

(51) Int. Cl. B26F 3/00

(52) U.S. Cl. 225/105; 83/955

(57) ABSTRACT

An optical fiber cutting device including: a rotatable blade including positioning holes; a first fastening member that is engageable with said positioning holes; and a second fastening member that is engageable with said positioning holes. When said first fastening member is engaged with a first one of said positioning holes, said second fastening member is not engaged with any of said positioning holes. Thus, the blade is fixed in a non-rotating state after being rotated by a predetermined angle.

### CROSS-REFERENCE TO RELATED APPLICATIONS

This application is based upon and claims the benefit of priority under 35 U.S.C. §119(a) from Japanese Patent Application No. 2005-063953, filed on Mar. 8, 2005, in the Japanese Patent Office, the disclosure of which is incorporated herein in its entirety by reference.

### BACKGROUND OF THE INVENTION

1. Field of the Invention

Devices, systems, and methods consistent with the invention relate to optical fiber cutting.

2. Description of the Related Art

In the related art, an optical fiber cutting device has been proposed wherein a disk-like blade having a cutting edge at a circumference thereof is rotatably mounted so as to utilize an unused portion of the cutting edge by rotating over a used portion of the cutting edge, when the used portion of the cutting edge has been worn down. This results in a longer lifetime of the cutting edge. In this device, the optical fibers are cut off while keeping the cutting edge fixed in a non-rotating state.

FIG. 1 is a front view showing an example of an optical fiber cutting device of related art, FIG. 2A is a plan view and FIG. 2B is a side view thereof.

A cutting procedure using an optical fiber cutting device 110 is performed such that an optical fiber 101 is held at a top portion and bottom portion thereof by two clamps 121 (121a, 121b), 122 (122a, 122b), the cutting edge of the blade 150 is moved toward an intermediate portion of the optical fiber between the held positions in a direction perpendicular to the longitudinal direction of the optical fiber to make a cut in a surface of the optical fiber 101, and a pillow (a pressing member) 123 is pressed against the optical fiber 102 from the rear side opposite to the cut.

It is important for obtaining a good section that the cut made in the optical fiber 101 has a proper size and depth. Therefore, the relative height of the cutting edge to the optical fiber 101 requires proper adjustment. The blade 150 is supported free to rotate on a blade holder 135 with a rotary shaft 137.

The height of the edge moves up and down through swinging of the blade holder 135 on the axis of a support shaft 134 parallel to the axial direction of the rotary shaft 137. By rotating an adjustment screw 136, the blade 150 moves up and down on the axis of the support shaft 134.

After repeatedly cutting optical fibers 101, a portion of the cutting edge is worn down gradually, resulting in poor cutting. Then, good cutting can be again performed using an unused portion of the cutting edge by rotating the blade 150 on the axis of the rotary shaft 137 only by an angle corresponding to the rotary pitch between two adjacent holes of the positioning holes.

In order to set each of rotated positions of the cutting edge, there are several positioning holes 151 in the blade 150 along the circumference thereof, and the rotated position of the cutting edge is set using a setscrew 141 in one of these holes. Thus, when the cutting edge is rotated to come full circle, there remain no unused portions of the cutting edge and the blade 150 should be replaced with a new one.

There is also a type of optical fiber cutting device where the blade 150 has no positioning holes and may be set by just holding both sides of the edge. Namely, there are only indicative divisions or numbers 154 printed on the side of the blade 150, and when a portion of the cutting edge is worn down, the edge is rotated by one division and the both sides of the blade 150 is held using a setscrew 141 to set the rotated position of the cutting edge, and thus an unused portion of the cutting edge will be utilized.

### SUMMARY OF THE INVENTION

However, there have been the following problems in the related art optical fiber cutting device 110 discussed above.

As shown in FIG. 3, whenever a portion of the cutting edge is worn down, another portion thereof is positioned according to the rotational movement of the cutting edge from one hole to the next of the positioning holes. Thus, unused portions 153 undesirably remain between the used portions 152.

In order to use up all of the portions of the cutting edge, as shown in FIG. 4, the number of the positioning holes 151 could be increased. However, if the number of the positioning holes 151 is increased, the intervals between the holes become narrower, the strength decreases, and manufacturing thereof comes more difficult, resulting in the higher production cost of the blade 150.

Further, as shown in FIG. 5, when the positioning holes 151 are formed farther from the center of blade 150, the number of the positioning hole 151 can be increased keeping the intervals between the holes at a reasonable level. In this case, however, as the number of the holes increases, the production cost becomes higher. Additionally, since the positioning holes 151 are near the cutting edge, internal defects are liable to occur resulting in nicks of the cutting edge especially in such a case where the blade 150 may be made by molding or sintering.

On the other hand, in such an optical fiber cutting device that a blade 150 has no positioning holes 151 and the edge is directly clamped on its side, the blade 150 may be used by intermittent rotation at a short segment so as to use full portions of the cutting edge because an angle of rotation of the blade 150 is not limited by the rotary pitch of the positioning holes 151. However, since accurate positioning cannot be achieved, there are such disadvantages that a part (near a boundary between the used and the unused portions) of the used portion 152 already worn down is undesirably reused and that the portion to be used next 152 is set up after skipping a large unused portion 153.

The invention has been made in view of the above problems. According to the invention, an optical fiber cutting device is provided where the number of positioning sites of the cutting edge can be greatly increased with respect to the number of positioning holes formed in the blade, and where the cutting edge can be accurately positioned at all the positioning sites.

According to an aspect of the invention, an optical fiber cutting device is provided, including: a rotatable blade including positioning holes; a first fastening member that is engageable with said positioning holes; and a second fastening member that is engageable with said positioning holes. When said first fastening member is engaged with a first one of said positioning holes, said second fastening member is not engaged with any of said positioning holes, where the blade is fixed in a non-rotating state after being rotated by a predetermined angle.

According to another aspect of the invention, an optical fiber cutting device is provided, including: a rotatable blade, comprising engagement elements disposed along a circumference thereof at a first pitch; a first fastening member that is engageable with said engaging elements; and a second fastening member that is engageable with said engagement elements, where said first fastening member and said second fastening member are separated in a direction along said circumference of said rotatable blade at a second pitch different from the first pitch.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a front view showing an example of a related art optical fiber cutting device;

FIG. 2A is a plan view of the optical fiber cutting device shown in FIG. 1, and FIG. 2B is a side view thereof;

FIG. 3 is a front view showing an example of a related art blade;

FIG. 4 is a front view showing another example of a related art blade;

FIG. 5 is a front view showing still another example of a related art blade;

FIG. 6 is a front view showing an exemplary embodiment of an optical fiber cutting device according to the invention;

FIG. 7A is a plan view of the optical fiber cutting device shown in FIG. 6, and FIG. 7B is a side view thereof;

FIGS. 8A and 8B are a plan view and a side view, respectively, showing a state where the used portion of the cutting edge has been switched around to an unused portion;

FIG. 9 is a front view of a cutting edge used for the optical fiber cutting device shown in FIG. 6;

FIG. 10A is a front view showing another exemplary embodiment of an optical fiber cutting device according to the invention, and FIG. 10B is a side view thereof; and

FIGS. 11A and 11B are a plan view and a side view, respectively, showing a state where the used portion of the cutting edge has been switched around to an unused portion.

### DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

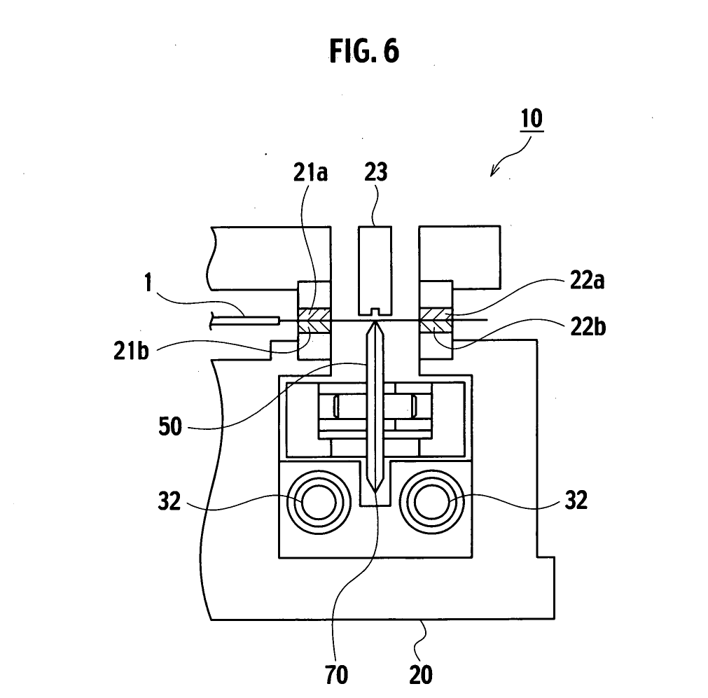

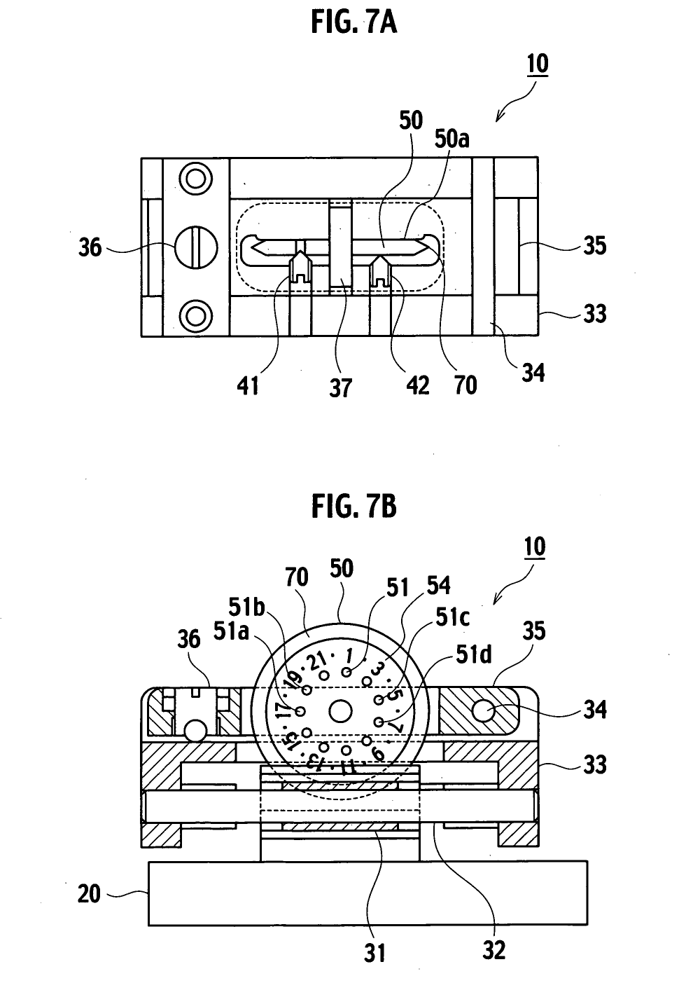

FIG. 6 is a front view showing an exemplary embodiment of an optical fiber cutting device according to the invention, and FIG. 7A is a plan view and FIG. 7B is a side view thereof.

The optical fiber cutting device 10 holds horizontally an optical fiber 1 with a pair of upper and lower clamps 21 (21a, 21b), 22 (22a, 22b) disposed on the left side and the right side of a base 20. A blade 50 is disposed between the clamps 21, 22, and is moved substantially perpendicularly to the principal axis of the optical fiber 1 to make a cut in a surface of the optical fiber 1 by a cutting edge 70. The optical fiber is cut off by applying stress to the cut through a push member 23 being pressed against the optical fiber 1 from the rear side opposite to the cut.

It is important for obtaining a good section in the optical fiber 1 that the cut made in the optical fiber 1 has a proper size. Therefore, the device is configured so as to adjust properly the height of the blade 50 relative to the optical fiber 1.

Namely, in the optical fiber cutting device 10, a sliding-guide shaft 32 is inserted through a slide bearing 31 disposed in the base 20 and a sliding block 33 moves linearly substantially in the horizontal direction.

A blade holder 35 is attached via a support shaft 34 to the sliding block 33 pivotably around the horizontal support shaft 34 perpendicular to the sliding-guide shaft 32, and by rotating an adjustment screw 36, the blade holder 35 can pivot like a cantilever up and down on the axis of the support shaft 34.

The blade 50 is attached to the blade holder 35 rotatably around a rotary shaft 37 parallel to the support shaft 34. Therefore, the height of the cutting edge 70 relative to the optical fiber 1 can be adjusted up and down by rotating an adjustment screw 36.

After repeatedly cutting the optical fibers 1, a used portion of the cutting edge of the blade 50 is worn down gradually resulting in poor cutting. Then, good cutting can be again achieved using an unused portion of the cutting edge through rotating the blade 50 by a predetermined angle around the rotary shaft 37.

In order to position the blade at the given position and to fasten it up to the blade holder, a plurality of positioning holes 51 as an engagement element are formed in the side 50a of the blade 50 at substantially even intervals along a circumference with an appropriate radius.

In the optical fiber cutting device 10, two fastening members 41, 42 are provided for engaging with any particular ones of the positioning holes 51 arranged along the circumference in order to fasten up the cutting edge 70 in a non-rotating state to the blade holder. The two fastening members are positioned so that they should alternatively engage with the positioning holes as the blade is rotated. Namely, when the first fastening member 41 (42) is engaged with one of the positioning holes 51, the second fastening member 42 (41) is engaged with none of the positioning holes. As the blade 50 is then rotated clockwise or counterclockwise, the second fastening member will be engaged with the other one of the positioning holes, but the first fastening member will be engaged with none of the positioning holes. A positioning mechanism shown in FIGS. 7A, 7B has an odd number of the positioning holes 51, and the fastening member 41, 42 are disposed at the locations opposite to each other in respect of the rotary shaft 37. Namely, in the positioning mechanism, the positioning holes 51 as an engagement element are arranged at substantially even intervals along the circumference around the rotary shaft 37 in the side 50a of the blade 50 and the two fastening members engaging with any ones of the positioning holes 51 have different rotary pitches in such a way that they cannot engage simultaneously with two of the positioning holes. As a result, the two fastening members can be alternately engaged with one of the positioning holes when the cutting edge 70 is rotated clockwise or counterclockwise. In a case where the number of the positioning holes is an even number, the two fastening members are disposed offset from the mutually right opposite location.

The fastening members 41, 42 are, for example, setscrews, and are engaged with the positioning holes 51 or released from the positioning holes 51 through operations of being tightened or loosened.

As shown in FIGS. 7A and 7B, while the fastening member 41 is engaged with the positioning hole 51a of the blade 50, the fastening member 42 is disposed so as to be located substantially at the center between the two positioning holes 51c, 51d adjacent to each other.

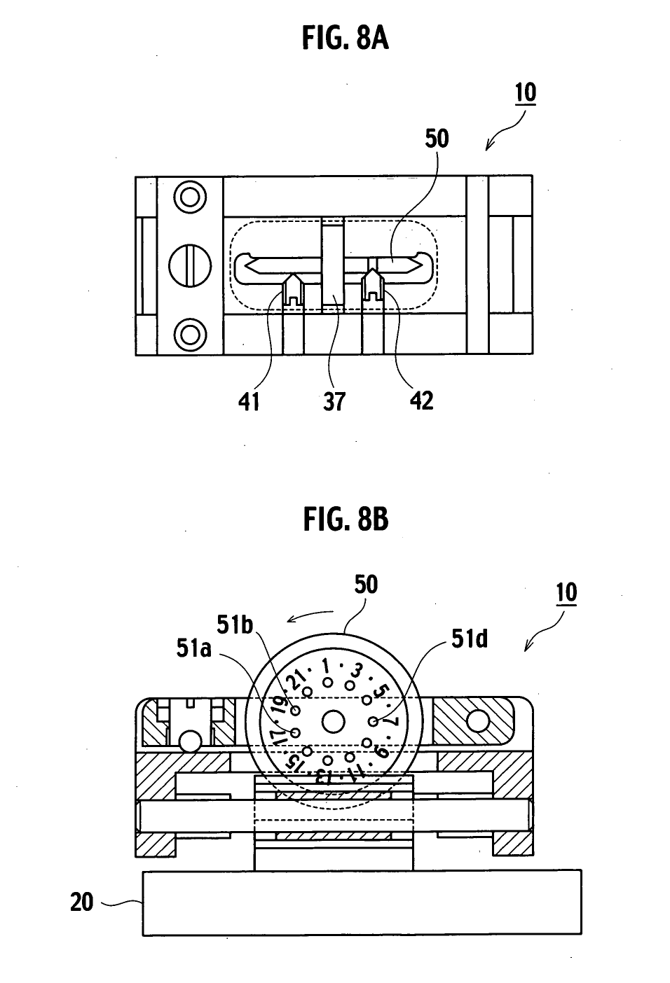

As shown in FIGS. 8A and 8B, while the fastening member 42 is engaged with the positioning hole 51d of the blade 50, the fastening member 41 is disposed so as to be located at the middle point (center) between the two positioning holes 51a, 51b adjacent to each other.

In other words, the number of the positioning holes 51 disposed in the blade 50 is half of the number of the positioning sites of the blade 50, which are able to be positioned using the positioning holes 51 and the two fastening member 41, 42. In a backward expression, the number of the positioning sites of the blade 50, which are able to be positioned using the positioning holes 51 and the two fastening member 41, 42, is twice as many as the number of the positioning holes 51 disposed in the blade 50.

In the blade 50 shown in FIGS. 7A and 7B, and FIGS. 8A and 8B, the number of positioning holes 51 is eleven and the positioning can be done at twenty-two sites. In other words, the positioning can be done at twice as many sites as the number of the positioning holes 51, and it is only necessary to form half the number of the positioning holes 51 in the blade 50 with respect to the number of positioning sites. Since the second fastening member is disposed at the middle point (center) between two positioning holes 51 adjacent to each other while the first fastening member is engaged with one of the positioning holes of the blade, the cutting edge 70 can be positioned by rotating the blade 50 at even intervals.

Additionally, it is possible to configure such a construction further using a third fastening member that while a first fastening member is engaged with one of the positioning holes, a second positioning holes and the third fastening member are arranged at two locations, respectively, which divide the rotary pitch of the positioning holes into three equal parts. In the case, since the first fastening member, the second fastening member, and the third fastening member, in this order for example, can be engaged one after the other with any of the positioning holes to be positioned during clockwise or counterclockwise rotation of the cutting edge, the rotary pitch of the rotation of the cutting edge comes to be substantially ⅓ of the pitch of the positioning holes.

The following will describe the method of rotating the blade 50 by the predetermined angle when a portion of the cutting edge of the blade 50 is worn down.

At the start, as shown in FIGS. 7A and 7B, one (51a) of the positioning holes 51 of the blade 50 is beforehand fastened up with a setscrew 41 as a fastening member. Setscrew 42 is at a portion where no positioning holes 51 exist (at the center between 51c and 51d), it is optional if the setscrew is fastened up or not.

In short, the blade 50 is positioned with one (51a) of the positioning holes 51 and the setscrew 41, and a first portion of the cutting edge is to be used.

Once the first portion of the cutting edge of the blade 50 is worn down, in order to use a second portion of the cutting edge, as shown in FIGS. 8A and 8B, the setscrew 41 is loosened, and the blade 50 is rotated by half of the rotary pitch of the holes in the direction of the arrow to fasten up one (51d) of the positioning holes 51 with the setscrew 42.

Since the location of the setscrew 41 is then just at the portion where no positioning holes 51 exist (at the center between 51a and 51b), it is optional if the setscrew is fastened up or not. In short, the blade 50 is positioned with one (51d) of the positioning holes 51 and the setscrew 42, and the second portion of the cutting edge is to be used.

And so forth, by fastening the positioning holes 51 using the setscrews 41, 42 alternately, the blade 50 is rotated by the angle corresponding to ½ of the pitch between the positioning holes 51, 51 adjacent to each other and then good cutting can be performed using an unused portion of the cutting edge every time.

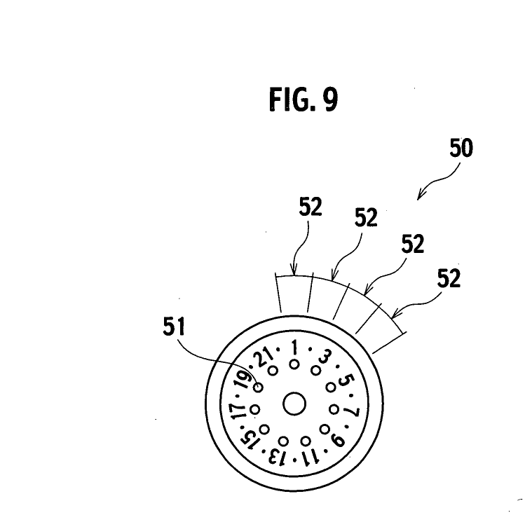

FIG. 9 shows the blade 50 used in the above exemplary embodiment. The blade 50 has eleven positioning holes 51 and twenty-two positioning sites (i.e., twice as much as the number of the holes).

As mentioned above, since the number of positioning sites of the blade 50 can be increased without increasing the number of positioning holes 51, the used portions 52 of the cutting edge are continuous with no waste areas therebetween (i.e., there remains no intervening unused portions between the used portion 52 and the used portion 52). Further, since the number of the positioning holes 51 is half of that of the positioning sites, the production cost of blade 50 can be spared.

Moreover, as the positioning can be always ensured with either of two fastening members (setscrews) 41, 42, the rotated position of the cutting edge is accurately determined.

Consequently, since the optical fiber cutting device 10 according to the invention can increase the number of positioning sites of a blade 50 relative to the number of positioning holes 51, the lifetime of the edge is lengthened. As the number of the positioning holes 51 can be decreased with respect to the positioning sites of the blade 50, the production cost of the cutting edges 50 can be reduced. Further, since the outer diameter of the blade 50 can be made smaller without reduction in the number of the positioning sites of the blade 50, the device can also be made smaller. Additionally, the blade 50 can be accurately positioned even when the number of the positioning sites thereof may be increased.

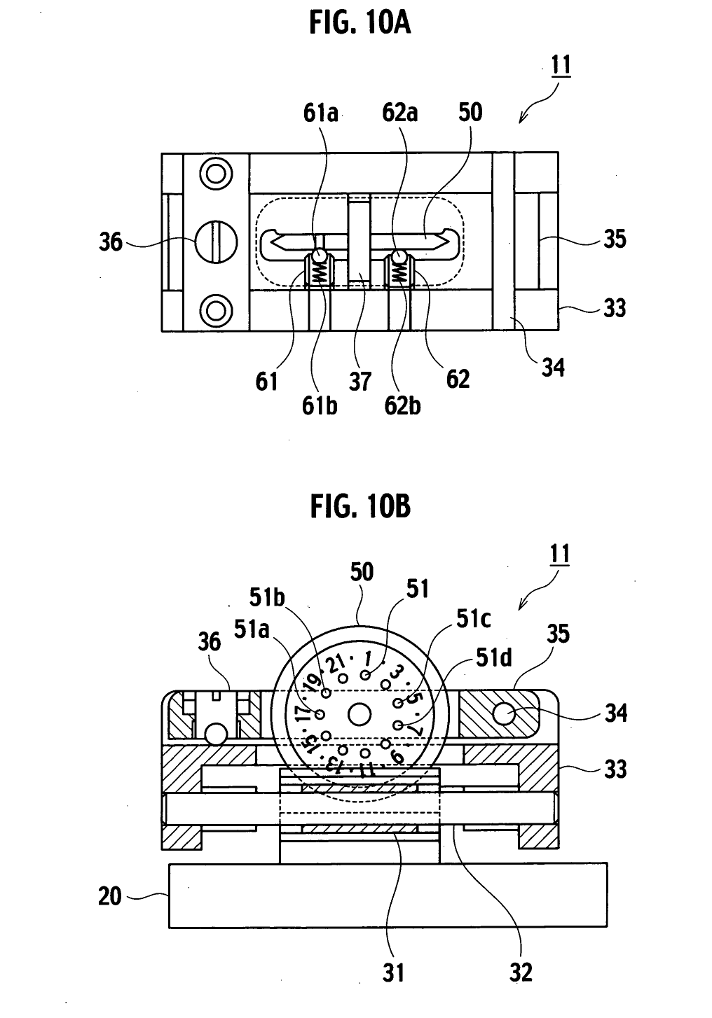

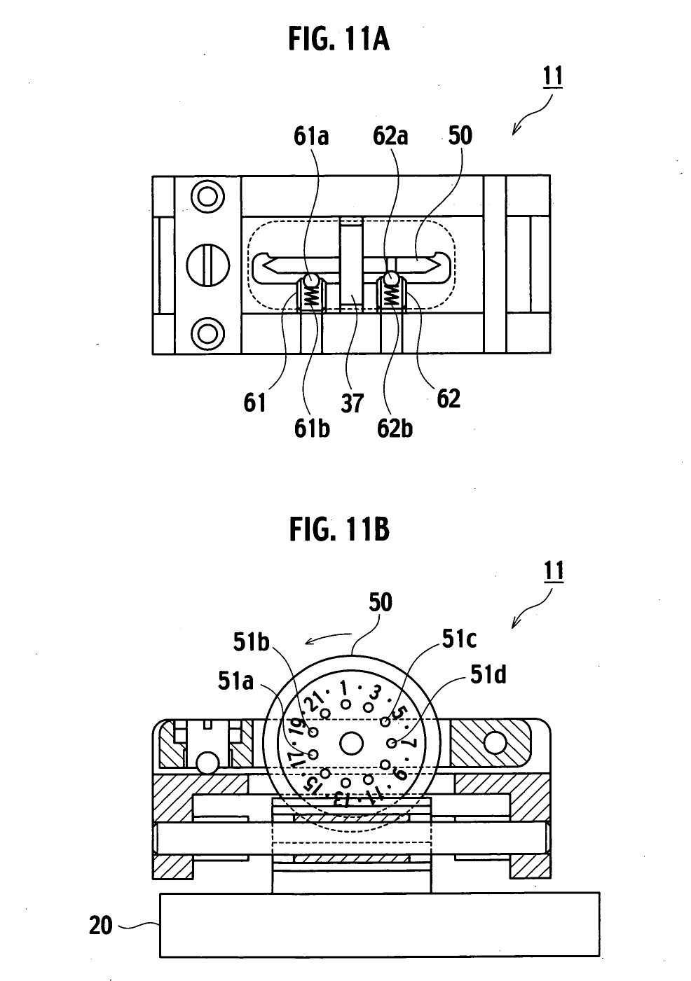

FIG. 10A is a front view showing another exemplary embodiment of an optical fiber cutting device according to the invention, and FIG. 10B is a side view thereof.

The optical fiber cutting device 11 employs a different type of fastening members 61, 62 in place of the fastening members 41, 42 such as, for example, a setscrew. The other components are similar to those in the optical fiber cutting device 10 as shown in FIGS. 6-8, and therefore repeated description will be omitted giving the like numerals to the corresponding components.

The fastening members 61, 62 are composed of plungers having pressing members 61b, 62b (e.g., a spring) which press engagement portions 61a, 62a (e.g., a ball) at the tip against positioning holes 51 of a blade 50.

Thus, the optical fiber cutting device 11 does not need any operation to tighten or loosen the fastening members 61, 62 (which are used for the fastening members 41, 42 shown in FIG. 7A), and the blade 50 can be easily positioned only through rotating it by the necessary angle.

The following will described the method of rotating the blade 50 by a predetermined angle when a portion of the cutting edge of the blade 50 is worn down.

At the beginning, as shown in FIGS. 10A, 10B, one (51a) of the positioning holes 51 of the blade 50 is beforehand fastened up with a fastening member (plunger) 61. As the location of a fastening member (plunger) 62 is just at the portion where no positioning holes exist (at the center between 51c and 51d), the tip of the fastening member (plunger) 62 gets dented.

In short, the blade 50 is positioned with one (51a) of the positioning holes 51 and the fastening member (plunger) 61, and a first portion of the cutting edge is to be used.

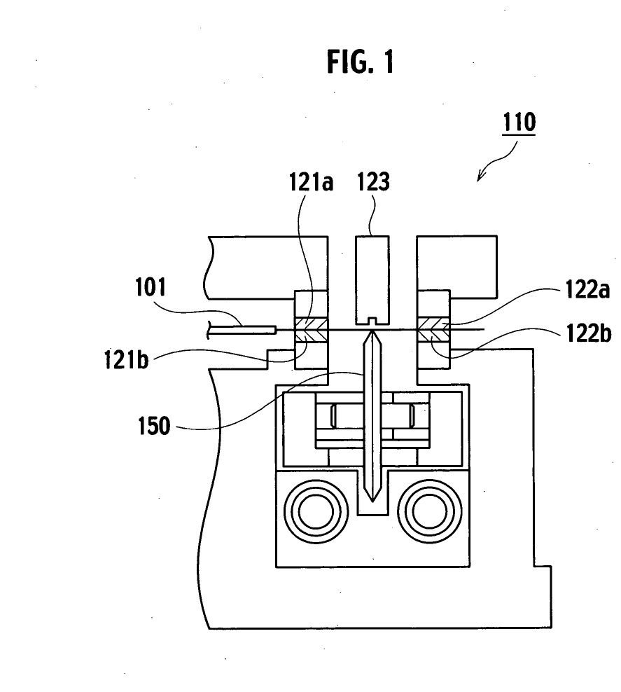

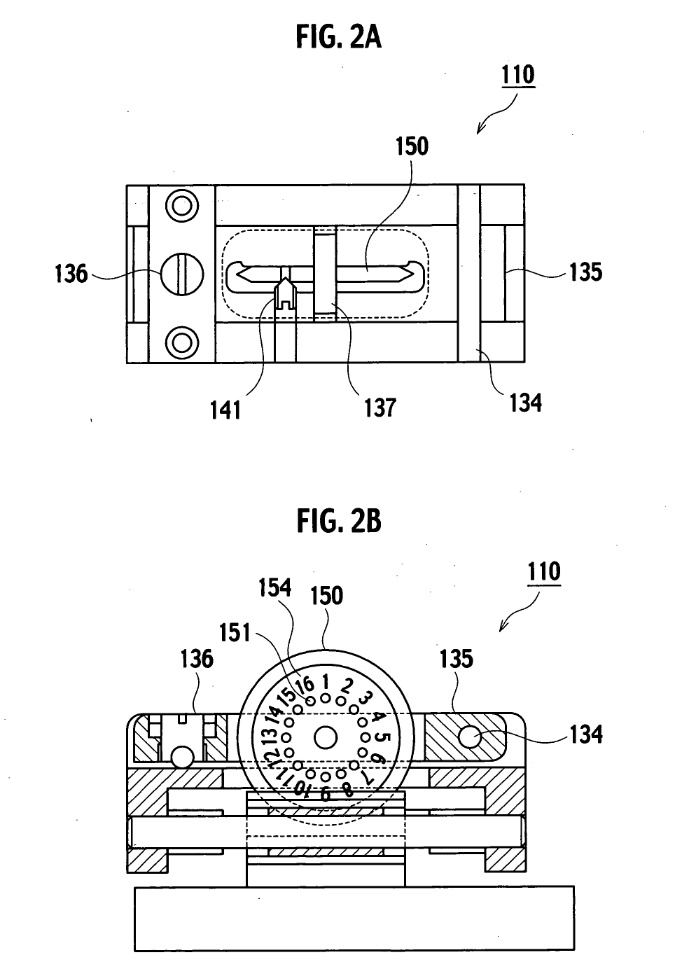

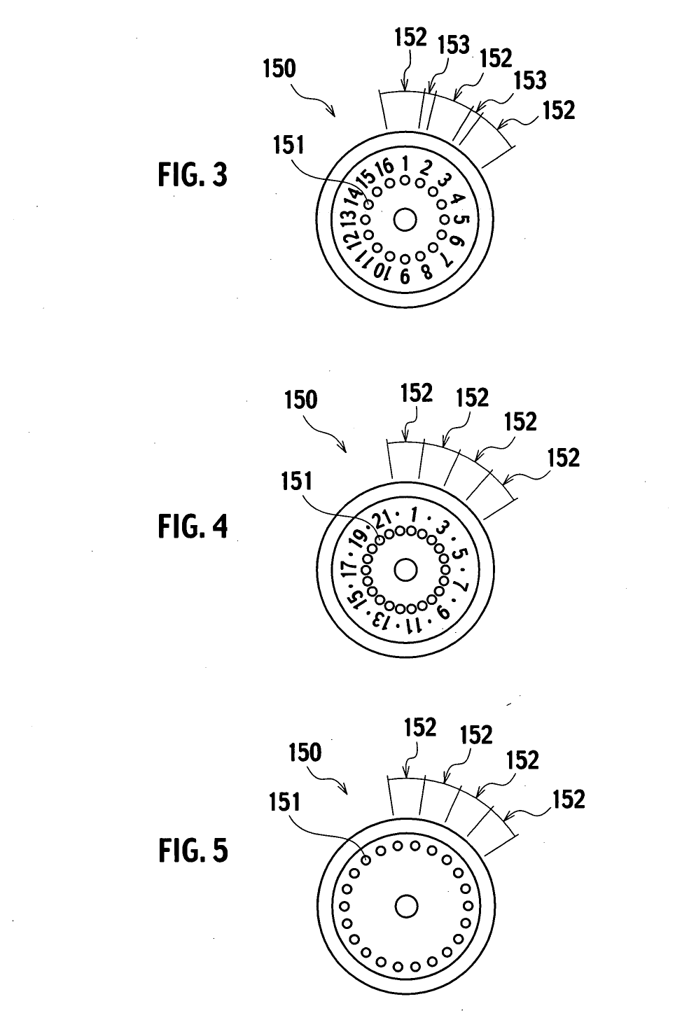

Next, once the first portion of the cutting edge of the blade 50 is worn down, in order to use a second portion of the cutting edge, as shown in FIGS. 1A, 1B, the blade 50 is rotated by half of the rotary pitch of the holes in the direction of the arrow and thus the fastening member (plunger) 61 is released from one (51a) of the positioning holes 51 and one (51d) of the positioning holes 51 is fastened automatically with the fastening member (plunger) 62.

Since the location of the fastening member 61 is then just at the portion where no positioning holes 51 exist (at the center between 51a and 51b), the tip of the fastening member (plunger) 61 gets dented. In short, the blade 50 is positioned with one (51d) of the positioning holes 51 and the fastening member (plunger) 62, and the second portion of the cutting edge is to be used.

And so forth, when an unused portion of the cutting edge is required to use, only through rotating the blade 50 by the angle corresponding to ½ of the rotary pitch between the positioning holes 51, 51 adjacent to each other, the alternate fastening member (plunger) 61 or 62 is engaged automatically with one of the positioning holes 51 leading to automatic positioning of the blade 50. And then good cutting can be performed using every time an unused portion of the cutting edge.

In the above exemplary embodiment, since the number of the positioning sites can be increased twice as much as the number of the holes 51 formed in the blade 50, there remains, as shown in FIG. 9, no intervening unused portions between the used portions 52. Since the number of the positioning holes 51 will do only by half of that of the positioning sites, the production cost of cutting edges 50 can be spared. Moreover, as the positioning can be always ensured with either of two fastening members (plungers) 61, 62, the rotated position of the cutting edge is accurately determined.

Consequently, since the optical fiber cutting device 11 according to the invention can increase the number of positioning sites of a blade 50 than that of positioning holes 51, the lifetime of the edge is elongated. As the number of the positioning holes 51 can be decreased than that of the positioning sites of the blade 50, the production cost of the cutting edges 50 can be reduced. Since the outer diameter of the blade 50 can be made smaller without reduction in the number of the positioning sites of the blade 50, the device can also be made compact. The blade 50 can be accurately positioned even when the number of the positioning sites thereof may be increased.

Further, through fastening the blade 50 with fastening members (plunger) 61, 62, it can be easily positioned only by simple rotation thereof.

As discussed above, the exemplary embodiments provide a blade where the number of positioning sites of a cutting edge is greater than a number of positioning holes, so that the cutting edge can be accurately positioned at each of the positioning sites.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. An optical fiber cutting device, comprising:
a rotatable blade comprising positioning holes;
a first fastening member that is engageable with said positioning holes; and
a second fastening member that is engageable with said positioning holes,
wherein, when said first fastening member is engaged with a first one of said positioning holes, said second fastening member is not engaged with any of said positioning holes.

2. The optical fiber cutting device of claim 1, further comprising a rotary shaft upon which said rotatable blade is arranged.

3. The optical fiber cutting device of claim 1, wherein the positioning holes are formed in a first surface of said rotatable blade.

4. The optical fiber cutting device of claim 1, wherein said positioning holes are formed at a first pitch along a circumference of said rotatable blade.

5. The optical fiber cutting device of claim 1, wherein, when said first fastening member is engaged with said first one of the positioning holes, said second fastening member is positioned at a middle point of an interval between adjacent second and third positioning holes of said positioning holes.

6. The optical fiber cutting device of claim 1, wherein, when said second fastening member is engaged with said first one of the positioning holes, said first fastening member is not engaged with any of said positioning holes.

7. The optical fiber cutting device of claim 6, wherein, when said second fastening member is engaged with said first one of the positioning holes, said first fastening member is positioned at a middle point of an interval between adjacent second and third positioning holes of said positioning holes.

8. The optical fiber cutting device of claim 1, wherein said first fastening member and said second fastening member each comprise a setscrew.

9. The optical fiber cutting device of claim 1, wherein said first fastening member and said second fastening member each comprise a pressing member and a tip portion directed toward said positioning holes of said blade.

10. The optical fiber cutting device of claim 8, wherein the tip portion is dome shaped.

11. The optical fiber cutting device of claim 1, wherein, an odd number of said positioning holes are provided, and said first fastening member and said second fastening member are located symmetrically with each other with respect to said rotatable blade.

12. The optical fiber cutting device of claim 1, further comprising a third fastening member that is engageable with said positioning holes, wherein, when said first fastening member is engaged with said first one of said positioning holes, said third fastening member is not engaged with any of said positioning holes.

13. The optical fiber cutting device of claim 12, wherein, when said second fastening member is engaged with said first one of the positioning holes, said first and third fastening members are not engaged with any of said positioning holes.

14. The optical fiber cutting device of claim 12, wherein, when said third fastening member is engaged with said first one of the positioning holes, said first and second fastening members are not engaged with any of said positioning holes.

15. The optical fiber cutting device of claim 1, wherein said first fastening member and said second fastening member are fixed to the optical fiber cutting device to remain stationary with respect to said rotatable blade.

16. The optical fiber cutting device of claim 1, wherein the rotatable blade comprises a first number of positioning sites for cutting; the rotatable blade comprises a second number of the positioning holes; and the first number is twice the second number

17. An optical fiber cutting device, comprising:
a rotatable blade, comprising engagement elements disposed along a circumference thereof at a first pitch;
a first fastening member that is engageable with said engaging elements; and
a second fastening member that is engageable with said engagement elements,
wherein said first fastening member and said second fastening member are separated in a direction along said circumference of said rotatable blade at a second pitch different from the first pitch.

18. The optical fiber cutting device of claim 17, further comprising:
a third fastening member that is engageable with said engagement elements,
wherein said second fastening member and said third fastening member are separated in a direction along said circumference of said rotatable blade at a third pitch different from the first pitch.
